(19) United States
(12) Patent Application Publication
(10) Pub. No.: US 2017/0151934 A1
(43) Pub. Date: Jun. 1, 2017

(54) AUTOMATED VEHICLE WASH AND POLISH APPARATUS

(71) Applicant: Bader Abdullah ALMALKI, Cedar Falls, IA (US)

(72) Inventor: Bader Abdullah ALMALKI, Cedar Falls, IA (US)

(21) Appl. No.: 14/953,668

(22) Filed: Nov. 30, 2015

(51) Int. Cl. B60S 3/04; B08B 1/00; B05B 9/04; B08B 3/10; B08B 1/04; B05B 9/00; B25J 9/16; B08B 3/02

(52) U.S. Cl. CPC B60S 3/04; B25J 9/163; B08B 1/002; B08B 3/02; B08B 3/10; B08B 1/04; B05B 9/002; B05B 9/0403; Y10S 901/01; Y10S 901/02; Y10S 901/30

(57) ABSTRACT

A system for cleaning, rinsing, drying, and polishing a vehicle surface having a robotic arm, a brush, a control system, wireless communication circuitry, and an electrical power source where the brush is mounted on the robotic arm, and the robotic arm is mounted on a vehicle and articulates about multiple axes and moves the brush over the vehicle surface, and the motor spins the brush, the movements based on a coordinate data set transmitted to the control system for operation on a specific vehicle type, make and model.

### BACKGROUND

Field of the Disclosure

The present disclosure is directed toward a system and method for the washing and polishing of vehicle exterior surfaces.

Description of the Related Art

Vehicles require periodic cleaning and polishing to extend the integrity of the exterior surface and improving the aesthetics of the vehicle. The most popular ways to clean and polish a vehicle include manually washing and polishing the vehicle or bringing the vehicle to a commercial facility that uses heavy machinery specifically to perform these tasks.

### SUMMARY

The present disclosure is directed toward an automated system and method for the washing and polishing horizontal, vertical, and compound surfaces, for a variety of vehicle types to provide necessary exterior maintenance and aesthetics.

The foregoing general description of the illustrative implementations and the following detailed description thereof are merely exemplary aspects of the teachings of this disclosure, and are not restrictive.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein:

FIG. 1 is a diagram of an embodiment of an automated process of washing and polishing vehicle;

FIG. 2 is a detailed diagram of an embodiment of a process of prioritizing operations of a washing and polishing apparatus;

FIGS. 3A, 3B, and 3C are plan, side, and front views, respectively, of an embodiment of a washing and polishing apparatus;

FIGS. 4A and 4B are detailed diagrams of a vehicle equipped with an embodiment of a vehicle water storage tank.

FIGS. 5A, 5B, and 5C are plan, side, and front views, respectively, of an embodiment of a track mount assembly;

FIGS. 6A, 6B, and 6C are plan, side, and front views, respectively, of an embodiment of a brush mount assembly;

FIGS. 7A and 7B are side views of an upper arm assembly, retracted and extended, respectively;

FIGS. 8A and 8B are side views of a forearm assembly, retracted and extended, respectively;

FIGS. 9A, 9B, 9C, 9D and 9E are plan, front, and side views, respectively, of an embodiment of a crosstrack assembly;

FIGS. 10A, 10B, and 10C are plan, side, and front views, respectively, of an embodiment of a paired revolute joint assembly;

FIGS. 11A and 11B are plan and side views, respectively, of an embodiment of a single revolute joint assembly;

FIGS. 12A and 12B are plan views of a vehicle without and equipped with an embodiment of a washing and polishing apparatus, respectively;

FIG. 13 is a detailed diagram of an embodiment of a process of washing and polishing a vehicle surface.

### DETAILED DESCRIPTION OF THE EMBODIMENTS

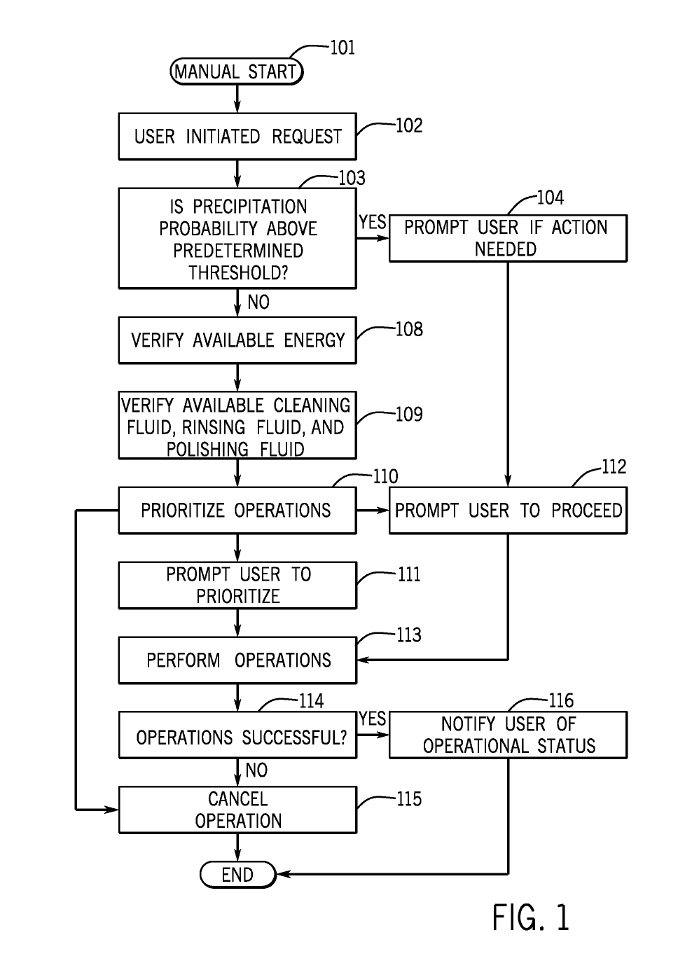

FIG. 1 is a diagram of an embodiment of an automated process of washing and polishing a vehicle and performed by the control module 6 of a washing and polishing apparatus 1 to initiate a vehicle washing and polishing operation.

Step 101 is the beginning of a user initiated manual start process for the operation of the vehicle wash and polish apparatus 1.

At Step 102 the control module 6 receives the user's request for the vehicle wash and polish apparatus 1 to begin operating.

At Step 103 the control module 6 determines if the likelihood of precipitation is above a predetermined probability for a predetermined future time window by communicating with external sources, for example wirelessly using wireless circuitry 14, and receiving weather forecasts based on, for example, the probability of precipitation, accumulation and ambient temperatures of the GPS location of the vehicle wash and polish apparatus 1. If criteria for inclement weather are met the control module 6 proceeds to Step 104. If not the control module 6 proceeds to Step 108.

At Step 104 the control module 6 prompts the user to determine if the vehicle should be washed, polished, dried, or be moved to collect water for the water storage tank 600. The water collected in the water storage tank 600 can be used to supplement the rinse fluid.

At Step 108 the control module 6 checks the energy available in a battery 2 or other energy source.

At Step 109 the control module 6 calculates total available rinse fluid, cleaning fluid and polishing fluid level based on the amount of fluid dispensed during previous uses, as measured by the flow meter 8, since the installation of each reservoir 50.

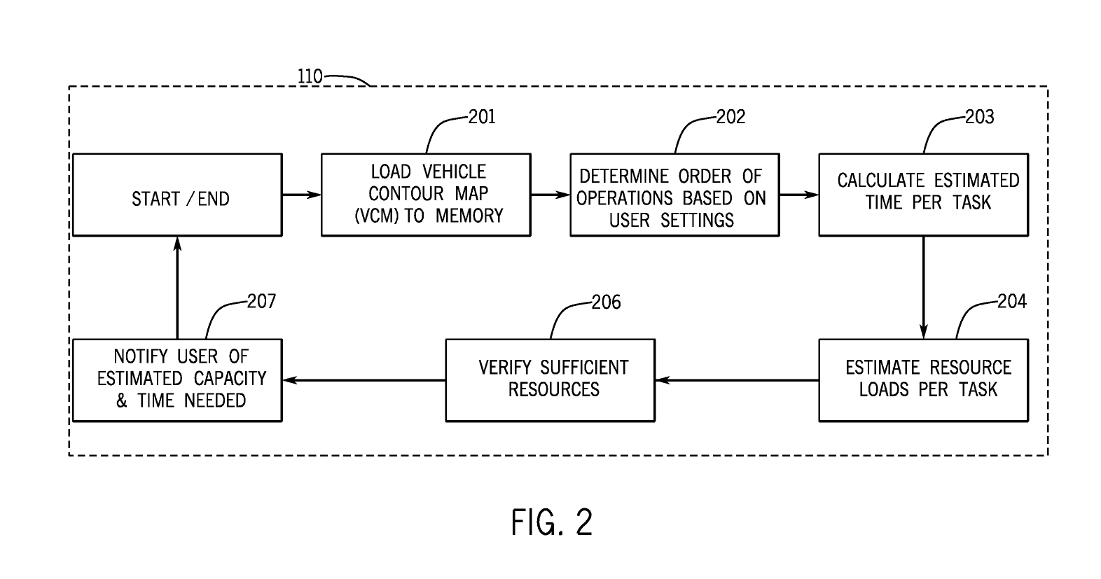

At Step 110 the control module 6 prioritizes the order of operations of the apparatus. A detailed description of Step 110 is provided in FIG. 2. If there are sufficient resources for completion of all the tasks then the control module 6 proceeds to Step 112. If there are not sufficient resources for completion of all the tasks then the control module 6 proceeds to Step 111.

At Step 111 the control module 6 prompts the user to prioritize and select the tasks to be performed by the vehicle wash and polish apparatus 1 for which there is sufficient energy, rinse fluid, cleaning fluid, and polishing fluid. The tasks are prioritized by default by the control module 6 with the user provided the choice to either approve, reprioritize the order of selected tasks, or cancel the operation.

At Step 112 the control module 6 estimates there are adequate resources to complete all of the selected tasks, and the user is prompted to proceed or cancel the operation.

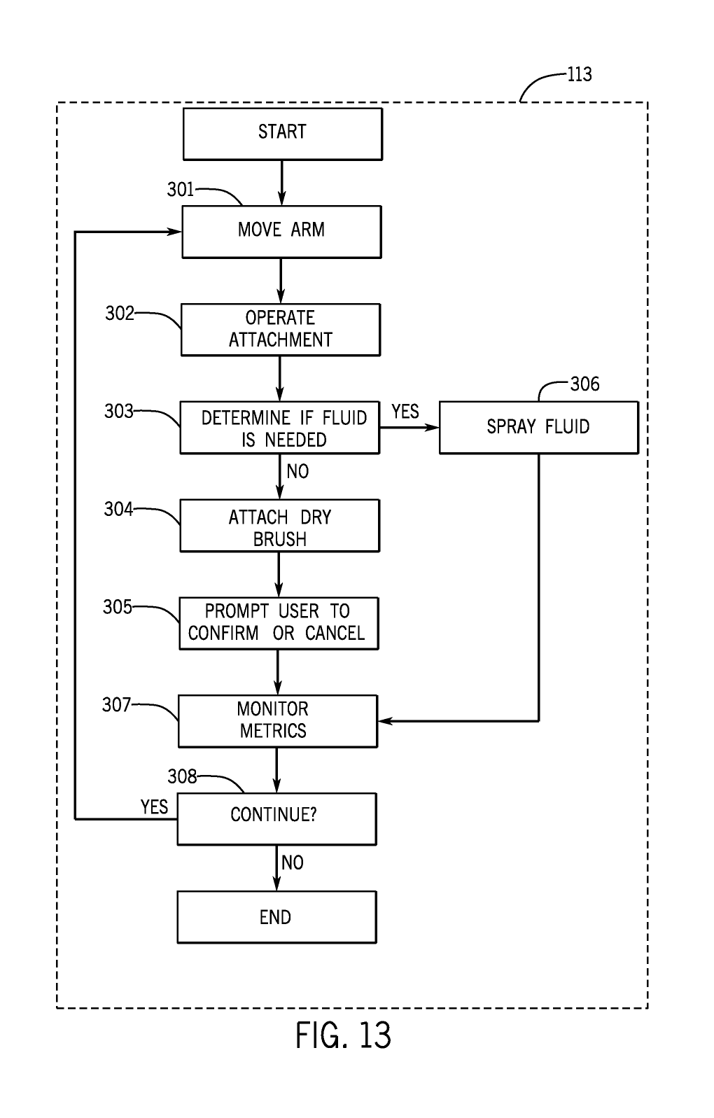

A detailed description of Step 113 is provided in FIG. 13.

Step 114 the control module 6 determines if all the scheduled tasks were completed. If so then the control module 6 proceeds to Step 116. If not then the control module 6 proceeds to Step 115.

At Step 115 the control module 6 determines if the operation was canceled or unsuccessful, and the user is provided with confirmation or informed of the technical issue resulting in the automatic cancellation of the operation.

At Step 116 the user is notified of successful completion of the operation.

FIG. 2 is a detailed diagram of an embodiment of a process, shown at Step 110 (FIG. 1), performed by the control module 6 to prioritize operations.

At Step 201 the control module 6 loads a Vehicle Contour Map (VCM) to memory 7. The VCM is a data set of coordinates specific to the type of vehicle 98 model the vehicle wash and polish apparatus 1 is connected to, telling the vehicle wash and polish apparatus 1 areas of the surface to move over or avoid. The VCM is obtained in a number of ways, for example pre-installed in the control module 6, downloaded from a database via the wireless circuitry 14, or created by the control module 6 based on an initiation procedure upon installation of the vehicle wash and polish apparatus 1 on a vehicle. The control module 6 can verify the accuracy of a downloaded or preloaded VCM by comparing it to coordinate data obtained through at least one torque sensor 4 or at least one torque sensor 5 as part of the initiation procedure. The VCM can be revised or edited by user input to account for particular areas of the vehicle 98 to accommodate inaccuracies or vehicle customization.

The position of the brush 56 and the vehicle wash and polish apparatus 1 relative to the vehicle are determined by the control module 6. The control module 6 identifies the location of the vehicle wash and polish apparatus 1 by making contact between the brush 56 and the vehicle at a number of points on the vehicle and comparing those coordinates to the data of the VCM.

The VCM represents the vehicle surface as a number of zones or areas, each with coordinate data specific to that zone, for example the hood, roof, driver door, passenger doors, windshield, the passenger side glass, the driver side glass, the rear window, the rear portion of the vehicle to include the trunk or hatch. Thus the control module 6 determines and prioritizes the number of tasks needed to perform wash, rinse, dry, and polish process for the entire vehicle 98 surface.

At Step 202 the control module 6 loads default user settings from the memory 7 and determines the order of operations based on those user settings.

At Step 203 the control module 6 calculates the estimated time to perform each task based on the rotational speed of the brush 56 and an assumed dirt area coverage and density on each vehicle surface zone, how fast the vehicle wash and polish apparatus 1 moves, and how much rinse fluid, cleaning fluid and polish fluid is needed for the spray interval for a given zone.

At Step 204 the control module 6 estimates resource loads to complete each task based on the information obtained in Steps 103, 108, 109 (FIG. 1), and operations identified in Step 202.

At Step 206 the control module 6 compares the resource load from Step 204 with the available resources from Step 108 and Step 109 to determine if sufficient energy, rinse fluid, cleaning fluid, and polishing fluid resources are available to complete the tasks for the given VCM.

At Step 207 the control module 6 notifies the user of estimated resource capacity and time needed. Resources include energy, rinse fluid, cleaning fluid, and polish fluid. Upon completion of this operation, described by FIG. 2 the control module 6 proceeds to either Step 111 or Step 112 (FIG. 1), depending on the outcome of Step 206.

At Step 207 the control module 6 notifies the user of the estimated capacity available and the time needed to complete the selected tasks of the operation.

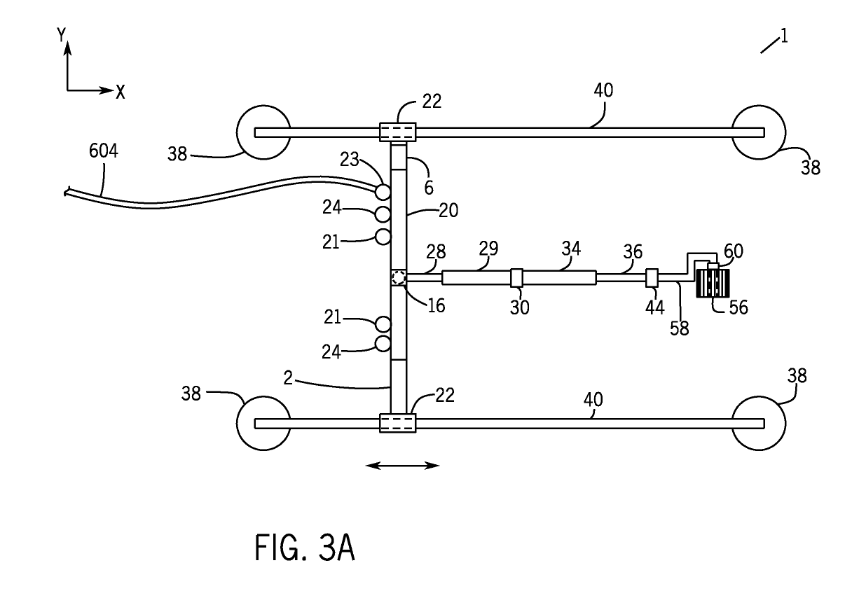

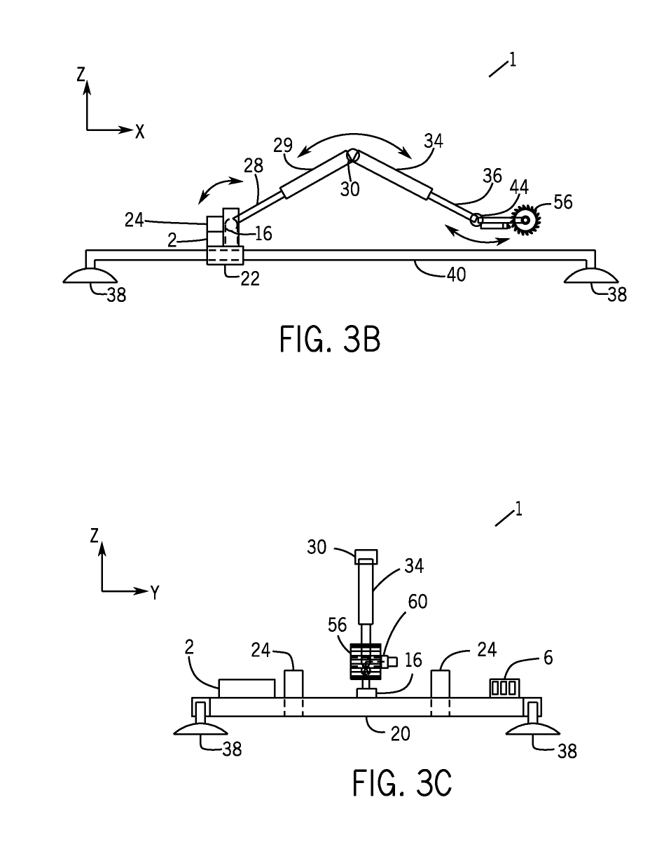

FIGS. 3A, 3B, and 3C are plan, side, and front views, respectively, of an embodiment of a vehicle wash and polish apparatus 1 having linear motors 22 and track mounts 40. Each track mount 40 is attached to a mounting 38 at each end. The slider 22 slides along the length of the track mount 40, described as the X-axis.

In this embodiment the track mount 40 serves as the primary, akin to the stator of a rotating electric motor, while the slider 22 serves as the secondary, akin to the rotor of a rotating electric motor, the combination operating as a linear motor.

Each slider 22 is connected to the opposite slider 22 by a crosstrack 20, the crosstrack 20 having a control module 6, a base joint assembly 16, a battery 2, at least two cleaning fluid reservoir mounts 24, at least one rinse fluid reservoir mounts 23 with an attached outtake tube 604, and at least two polish fluid reservoir mounts 21. The base joint assembly 16 is connected to an upper arm B 28, an upper arm A 29, an elbow joint 30, a forearm A 34, a forearm B 36, a wrist joint assembly 44, a brush mount 58, a brush motor 60, and a brush 56. The base joint assembly 16 rotates about the Y and Z axes. The elbow joint 30 rotates about the Y axis. The wrist joint assembly 44 rotates about the X and Y axes in this diagram. The brush 56, the brush mount 58, and the brush motor 60 pivot about the wrist joint assembly 44. The forearm A 34 and the forearm B 36 form the forearm assembly 32, which telescopes and pivots about the elbow joint 30. The upper arm B 28 and upper arm A 29 form the upper arm assembly 27, which telescopes and pivots about the base joint assembly 16.

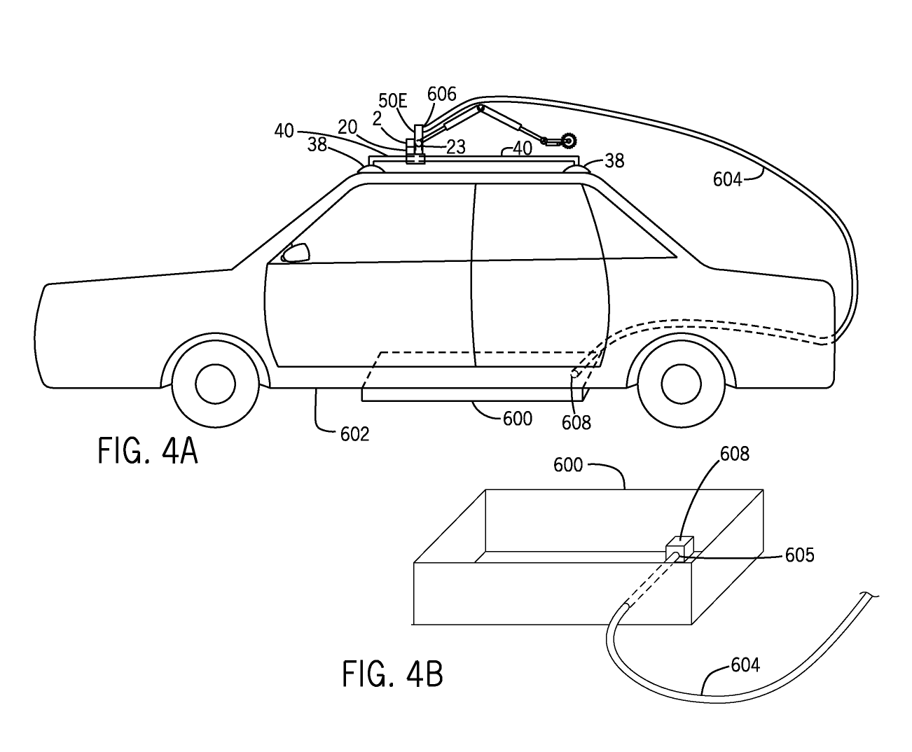

FIGS. 4A and 4B are detailed diagrams of an embodiment of a vehicle 98 equipped with an embodiment of a vehicle wash and polish apparatus with the water storage tank 600 located on the underside of the vehicle 602. The water storage tank 600 houses a pump 608. An end of the outtake tube 605 affixed to the output of the pump 608 and an opposing end of the outtake tube 606 attached to the fifth reservoir 50E to replenish the rinse fluid in the fifth reservoir 50E. The pump 608 forces the water from the water storage tank 600 into the fifth reservoir 50E. At a point where the rinse fluid in the water storage tank is depleted, the user is notified to refill the water storage tank 600. The water storage tank 600 is filled manually and additionally receives water in the form of condensation from the vehicle's exhaust system and air conditioning system.

FIG. 4B is a profile view of an embodiment of a water storage unit 600 of washing and polishing apparatus having a pump 608 used to pump water into the affixed outtake tube 604 to the fifth reservoir 50E.

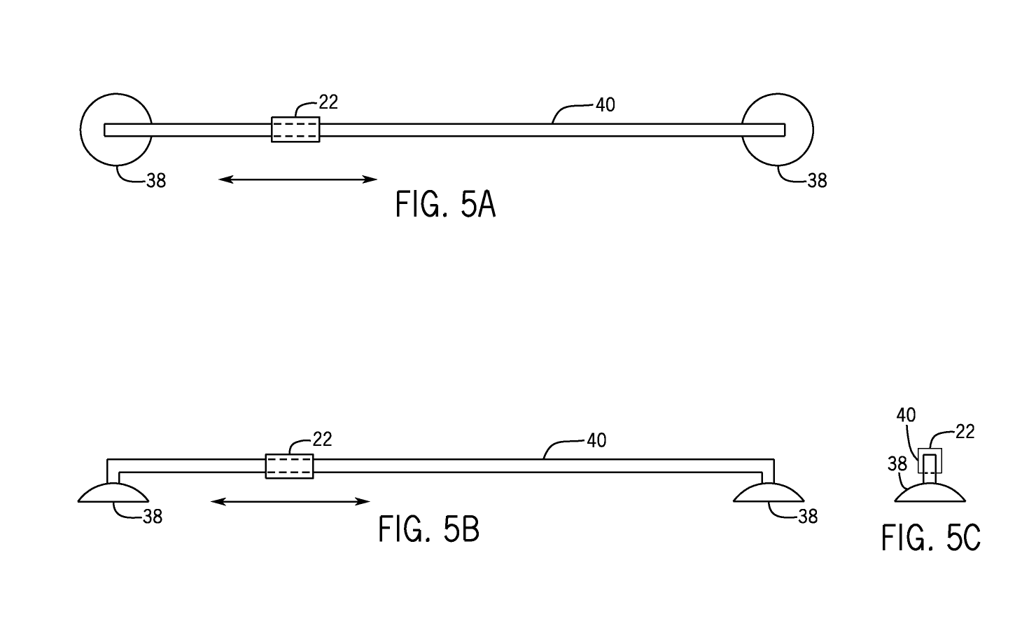

FIGS. 5A, 5B, and 5C are plan, side, and front views, respectively, of an embodiment of a track mount 40 having a mounting 38 at each end, the track mount 40 also having a slider 22 which is a prismatic joint that moves along the length of the track mount 40.

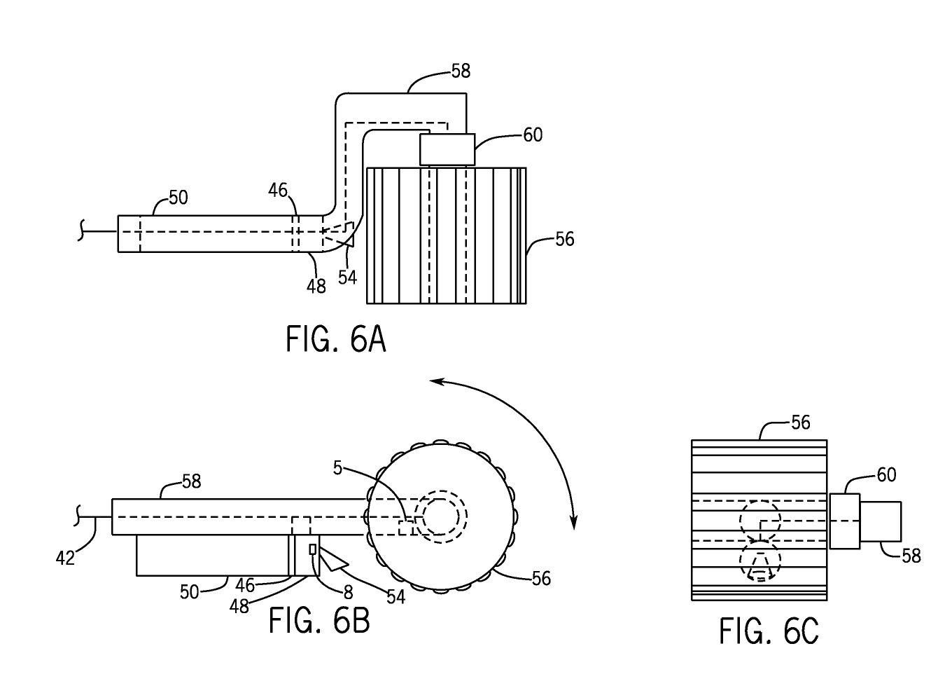

FIGS. 6A, 6B, and 6C are plan, side, and front views, respectively, of an embodiment of a brush mount 58 connected to a reservoir 50, a heating element 46, a flow meter 8, a pump 48, a spray nozzle 54, a contact sensor 5, a brush motor 60, and a brush 56, with a portion of a wiring harness 42 inside the brush mount 58 and terminating at the brush motor 60. The heating element 46 maintains temperature of the fluid in the reservoir 50 as it is pumped out by the pump 48 to the spray nozzle 54. The flow meter 8 measures fluid flow through the pump 48. The brush motor 60 controls the direction and rotational speed of the brush 56. Power for the heating element 46, the pump 48 and the brush motor 60 is supplied by the battery 2, and a wiring harness 42 connecting the battery 2 and the brush mount 58. The control module 6 controls the operation of the heating element 46, the pump 48, and the brush motor 60.

The brush 56 is substantially circular in its side profile. The surface of the brush 56 is shaped in a way to clean, dry, and polish the exterior of the vehicle as it rotates and slides over a vehicle 98 surface. It is connected to the brush motor 60 which rotates in either direction and at a speed that is in response to commands of the control module 6. The contact sensor 5 provides data to the control module 6 that contact has been made with a vehicle 98 surface or an unexpected object.

At a point when the cleaning fluid in the first reservoir 50A is depleted, if there is a second reservoir 50B with cleaning fluid located on one of the reservoir mounts 24 (FIG. 3) then the control module 6 rotates the brush mount 58 to an empty reservoir mount 24, removes the first depleted reservoir 50A, into the empty reservoir mount 24 and then repositions the brush mount 58 to remove the second reservoir 50B containing cleaning fluid. The brush mount 58 then snaps the second reservoir 50B into place and begins to monitor the temperature of the cleaning fluid inside the second reservoir 50B, heating it as necessary with the heating element 46, to a temperature sufficiently high to aid in cleaning the vehicle.

At a point when the polish fluid in the third reservoir 50C is depleted, if there is a fourth reservoir 50D with polish fluid located on one of the reservoir mounts 21 (FIG. 3) then the control module 6 rotates the brush mount 58 to an empty reservoir mount 21, removes the third depleted reservoir 50C, into the empty reservoir mount 21 and then repositions the brush mount 58 to remove the fourth reservoir 50D containing polish fluid. The brush mount 58 then snaps the fourth reservoir 50D into place and begins to monitor the temperature of the polish fluid inside the fourth reservoir 50D, heating it as necessary with the heating element 46, to a temperature sufficiently high to aid in polishing the vehicle.

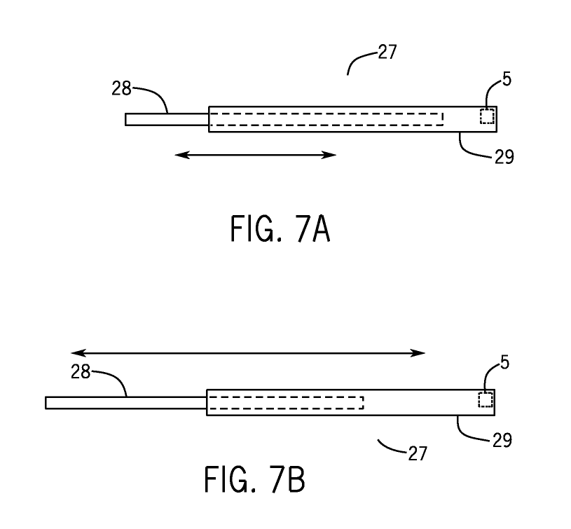

FIGS. 7A and 7B are side views of an embodiment of an upper arm assembly 27 having an upper arm A 29, an upper arm B 28, and at least one contact sensor 5. The upper arm B 28 is of a smaller cross section than the upper arm A 29 it is connected to. The upper arm B 28 and the upper arm A 29 form a prismatic joint with one degree of freedom where the upper arm B 28 telescopes from within the upper arm A 29 and extends outward along the length of the upper arm A 29, where they share a common longitudinal axis.

In this embodiment the upper arm A 29 and the upper arm B 28 form a linear motor, with one component serving as the primary and the other as the secondary (akin to a stator and rotor in a rotating electric motor), powered by the battery 2 and controlled by the control module 6. The free end of the upper arm A 29 is connected to the elbow joint 30. The free end of the upper arm B 28 is connected to the base joint assembly 16.

The contact sensor 5 provides data to the control module 6 that contact has been made with a vehicle 98 surface or an unexpected object.

In an alternate embodiment the upper arm A 29 and the upper arm B 28 are formed of hydraulic pistons and extend and retract by use of hydraulic fluid or compressed air.

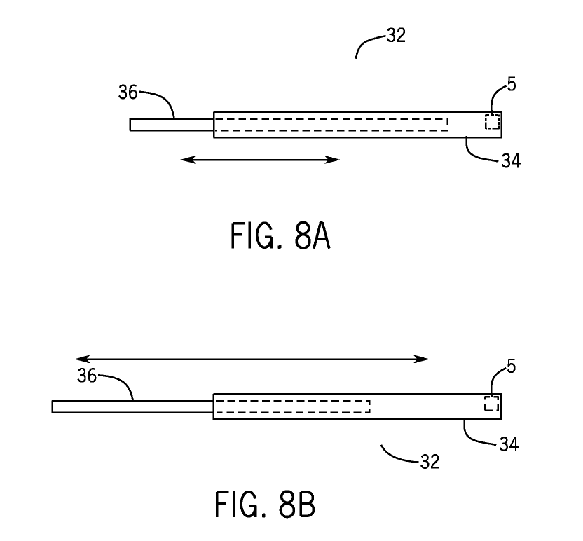

FIGS. 8A and 8B are views of an embodiment of a forearm assembly 32 having a forearm B 36, a forearm A 34, and at least one contact sensor 5. The forearm B 36 is of a smaller cross section than the forearm A 34 and is connected to the forearm A 34. The forearm A 34 and the forearm B 36 form a prismatic joint with one degree of freedom where the forearm B 36 telescopes from within the forearm A 34 and then extends outward along the length of the forearm A 34, where they share a common longitudinal axis.

In this embodiment the forearm B 36 and the forearm A 34 form a linear motor, with one component serving as the primary and the other as the secondary (akin to a stator and rotor in a rotating electric motor), powered by the battery 2 and controlled by the control module 6. The free end of the forearm A 34 is connected to the elbow joint 30. The free end of the forearm B 36 is connected to the wrist joint assembly 44.

The contact sensor 5 provides data to the control module 6 that contact has been made with a vehicle 98 surface or an unexpected object.

In an alternate embodiment the forearm B 36 and the forearm A 34 are formed of hydraulic pistons and extend and retract by use of hydraulic fluid or compressed air.

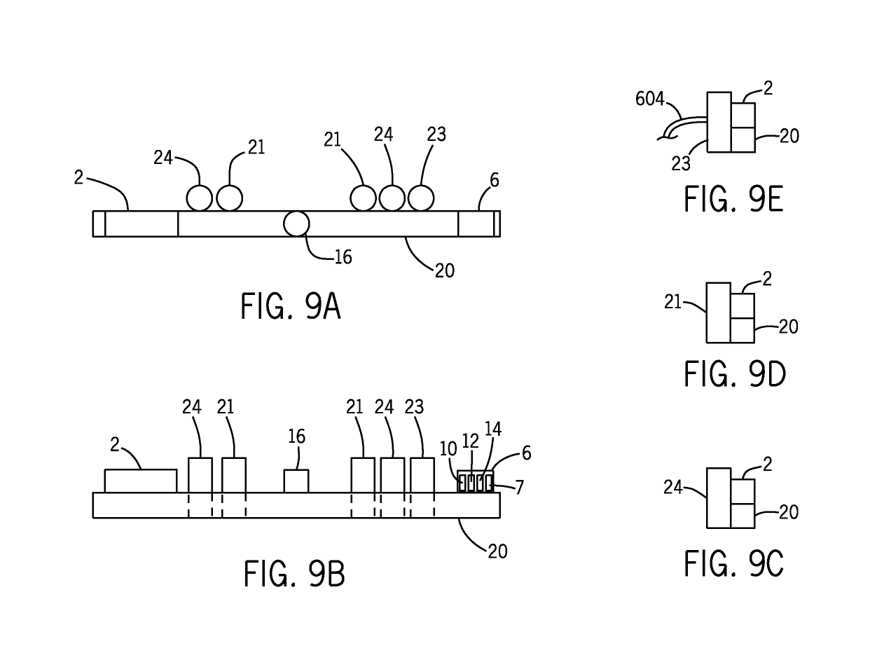

FIGS. 9A, 9B, 9C, 9D and 9E are plan, front, and side views, respectively, of an embodiment of a crosstrack 20 connected to a base joint assembly 16, a control module 6, a pair of cleaning fluid reservoir mount 24, a pair of polish fluid reservoir mount 21, and a rinse fluid reservoir mount 23.

The crosstrack 20 is connected at either end to a slider 22 (FIG. 3). The base joint assembly 16 is connected to the upper arm B 28 (FIG. 3).

The battery 2 provides power to the entire vehicle wash and polish apparatus 1, the main power consuming components of which are the control module 6, the base joint assembly 16, the slider 22 and track mount 40, the upper arm B 28, the upper arm A 29, a elbow joint 30, a forearm assembly 32, a forearm A 34, a forearm B 36, the wrist joint assembly 44, the brush motor 60, and the flow meter 8.

The control module 6 includes a clock 10, the temperature sensor 12, and wireless circuitry 14, and controls the movement of the vehicle wash and polish apparatus 1 and its operation, and its communication with any other device. The clock 10 is a clock used to time and schedule operations of the vehicle wash and polish apparatus 1. The temperature sensor 12 is used to gather data about ambient conditions and deicing fluid conditions. The wireless circuitry 14 is circuitry to send and receive data, for example through smart phones and other wireless devices.

Each cleaning fluid reservoir mount 24 holds a spare reservoir 50A and 50B which can be exchanged as needed by the vehicle wash and polish apparatus 1 for the reservoir 50 mounted on the wrist joint assembly 44. Each polish fluid reservoir mount 21 holds a spare reservoir 50C and 50D which can be exchanged as needed by the vehicle wash and polish apparatus 1 for the reservoir 50 mounted on the wrist joint assembly 44. The rinse fluid reservoir mount 23 holds the rinse fluid reservoir 50E on the wrist joint assembly 44. The rinse fluid reservoir 50E is replenished with the water stored in the water storage tank 600. The water storage tank 600 is positioned under the vehicle 602 and using a pump 608 forces water through the outtake tube 604 into the rinse fluid reservoir 50E.

In an alternate embodiment the battery 2 is charged by an external power source, for example a home charging system that plugs into a wall outlet, or a mobile or stationary electric vehicle charging station.

In an alternate embodiment the battery 2 is charged by the vehicle 98 battery or electrical system as needed. If the vehicle 98 battery charge falls below a predetermined threshold the control module 6 can automatically start the vehicle 98 or prompt the user to do so to maintain a steady power supply to complete the operation. The control module 6 may also account for the vehicle 98 fuel level as well, to ensure sufficient running time and driving range once the vehicle 98 is ready to drive.

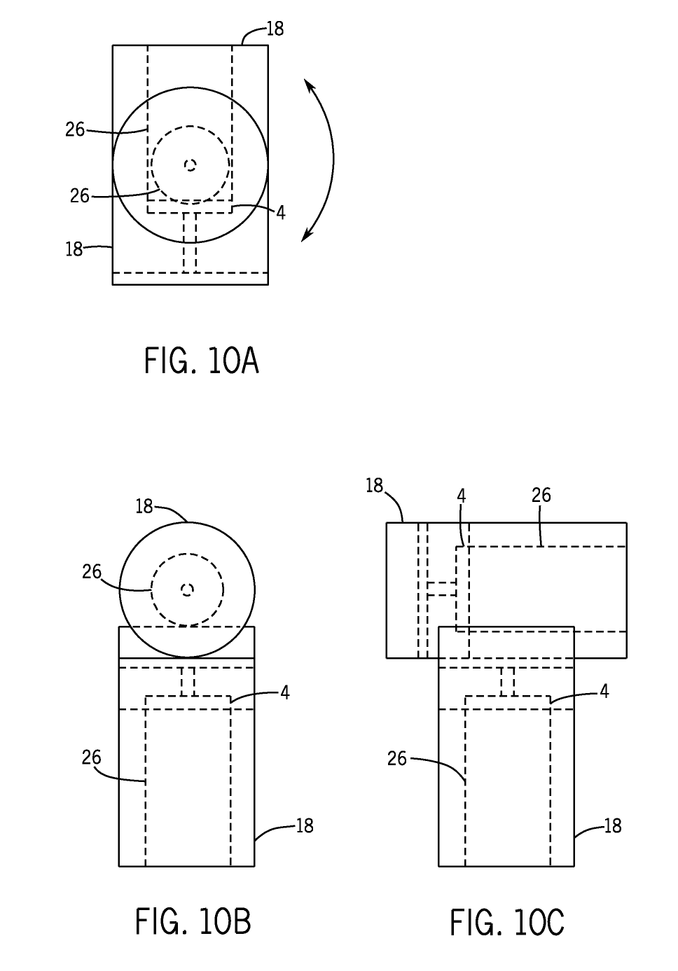

FIGS. 10A, 10B, and 10C are plan, side, and front views, respectively, of an embodiment of paired revolute joints 18, allowing rotational movement about two orthogonal axes, each revolute joint 18 having a stepper motor 26 and a torque sensor 4, the revolute joint 18 connected to another revolute joint 18 having a stepper motor 26 and a torque sensor 4. The first revolute joint 18 is orthogonal to the second revolute joint 18, with each revolute joint 18 rotates about an axis perpendicular to the axis of the other revolute joint 18.

The power for each stepper motor 26 is provided by the battery 2, and each stepper motor 26 is controlled by the control module 6. The base joint assembly 16 and the wrist joint assembly 44 are of this type of design.

The base joint assembly 16 is connected to the crosstrack 20 at one of the revolute joints 18, and the other revolute joint 18 is connected to the upper arm B 28. The wrist joint assembly 44 is connected at one of its revolute joints 18 by the forearm B 36 and its other revolute joint 18 is connected to the brush mount 58.

The base joint assembly 16 and the wrist joint assembly 44 each rotate about two axes (FIG. 3A, 3B, 3C).

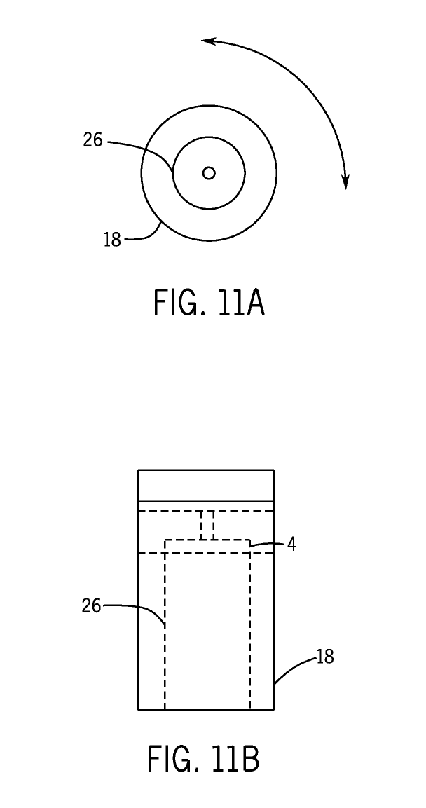

FIGS. 11A and 11B are plan and side views, respectively, of an embodiment of a single revolute joint 18. Power for the stepper motor 26 is provided by the battery 2, and the stepper motor 26 is controlled by the control module 6. This assembly is also used as an elbow joint 30. The elbow joint 30 is also connected to the upper arm A 29 and the forearm A 34, and rotates about one axis (FIG. 3A, 3B, 3C).

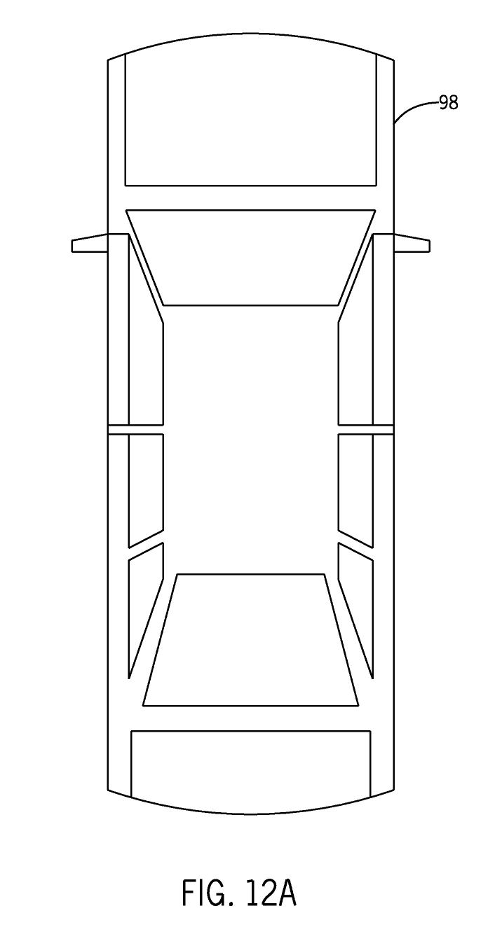

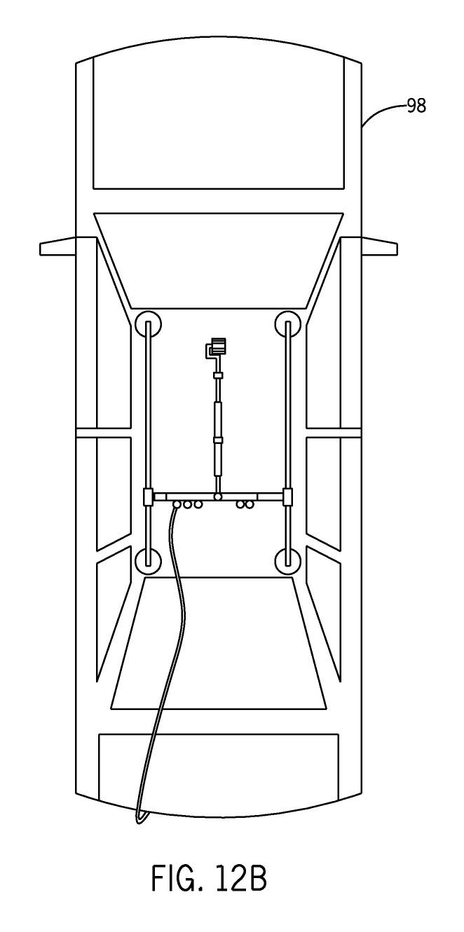

FIGS. 12A and 12B are plan views of a vehicle 98 without and equipped with an embodiment of a vehicle wash and polish apparatus 1, respectively.

FIG. 13 is a detailed diagram of an embodiment of a process, shown at Step 113 (FIG. 1), performed by the control module 6, for washing and polishing a vehicle 98 surface.

At Step 301 the control module 6 decides how the vehicle wash and polish apparatus 1 operates by the fore/aft movement of the linear motors 22 along the track mounts 40, followed by the simultaneous adjustment of the lengths of the upper arm A 29 and the forearm assembly 32 with the rotation of the base joint assembly 16 about the Z and Y axes, the rotation of the elbow joint 30 about the Y-axis, and the rotation of the wrist joint assembly 44 about the Y and X axes to achieve the needed positioning for each step of each task.

As the movements of the vehicle wash and polish apparatus 1 result in contact between the brush 56 and a part of the vehicle corresponding to a zone of the VCM, or unexpected contact between any part of the vehicle wash and polish apparatus 1 and an obstacle, it is detected by the at least one torque sensor 4 or the at least one contact sensor 5.

In one embodiment the torque sensor 4 senses torque resisting movement about a joint in which the torque sensor 4 is positioned. This data is used by the control module 6 to determine contact or obstacles. The control module 6 then decides whether to tilt or rotate components of the vehicle wash and polish apparatus 1 to accommodate continued activity or stops and prompts the user for input.

In another embodiment the vehicle wash and polish apparatus 1 is equipped with video capability transmitted by the wireless circuitry 14 for the user to remotely view dirt and pollen accumulation on the vehicle, progress of operation of the vehicle wash and polish apparatus 1, or to use for surveillance of the immediate area around the vehicle.

At Step 302 the control module 6 directs the brush 56 to begin rotation once in contact with a vehicle surface at a location corresponding to an area of the VCM that is represented by the current task in the planned order of operations.

At Step 303 the control module 6 identifies if the next operation requires either wash fluid, rinse fluid, or polish fluid, or if the next operation is to dry the vehicle. If the operation requires fluid, the process proceeds to Step 306. If the next process is to dry the vehicle the process proceeds to Step 304.

At Step 304 prompts the user to replace the current brush 56 with a dry brush 56. The process proceeds to Step 305.

At Step 305 the user is provided the choice to cancel or continue with the dry operation. Step 305 awaits the user to select continue to dry the vehicle or to cancel the task.

At Step 306 the control module 6 directs the pump 48 to dispense cleaning fluid, rinse fluid, or polish fluid as determined by the operations plan. During Step 113 (FIG. 1) the fluid in use, either the cleaning fluid, rinse fluid, or polish fluid is continuously heated by the heating element 46 and pumped by the pump 48 from the reservoir 50 and through the spray nozzle 54 on to the vehicle surface at periodic intervals.

At Step 307 the control module 6 continuously monitors and records sensor data to memory 7, for example the energy level in the battery 2, the fluid temperature, the need to replace the reservoir 50 connected to the brush mount 58 due to depleted cleaning fluid level, depleted rinse fluid level, or depleted polish fluid level, based on how much is dispensed through the pump 48 as measured by the flow meter 8, and the need to halt movement of any part of the vehicle wash and polish apparatus 1 due to any unexpected contact of any components such as the brush mount 58.

Further the actual movement of the linear motors 22, the base joint assembly 16, the upper arm B 28, the elbow joint 30, the forearm assembly 32, and the wrist joint assembly 44 are recorded and compared to the scheduled tasks to track coverage of the VCM.

At Step 308 the decision is made whether or not to continue operation of the vehicle wash and polish apparatus 1. The decision depends on whether the scheduled tasks are completed, the needed resources are depleted, or the vehicle wash and polish apparatus 1 detects a machine fault or unexpected contact, for example through the torque sensor 4.

If the control module 6 decides to proceed then it returns to Step 301 and continues. If the control module 6 decides to halt operations then it proceeds to Step 114 (FIG. 1).

In the drawings, like reference numerals designate identical or corresponding parts throughout the several views. Further, as used herein, the words “a”, “an” and the like generally carry a meaning of “one or more”, unless stated otherwise. The drawings are generally drawn to scale unless specified otherwise or illustrating schematic structures or flowcharts.

Referring now to the drawings, wherein like reference numerals designate identical or corresponding parts throughout the several views.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernable variants of the teachings herein, define, in part, the scope of the foregoing claim terminology such that no inventive subject matter is dedicated to the public.

What is claimed is:

1. A system for cleaning a vehicle surface comprising:
a mobile robotic arm;
a brush mounted on the robotic arm;
wireless communication circuitry;
an electrical power source that provides power to the wireless communication circuitry and the mobile robotic arm;
a water storage tank connected to the mobile robotic arm and configured to provide water to the brush; and
control circuitry configured to control the robotic arm and the wireless communication circuitry, wherein
said robotic arm is configured to be mounted on a vehicle and articulate about multiple axes and move the brush over the vehicle surface so as to clean the vehicle surface, and the communication circuitry is configured to receive a weather update and in response provide a signal to the control circuitry to control a movement of the water storage tank when the weather update indicate rain is expected.

2. The system according to claim 1 further comprising:
a motor configured to drive the brush in a spinning motion.

3. The system according to claim 1 further comprising:
a pump that pumps fluid through a line to the brush;
a flow meter connected to the line;
a spray nozzle connected to the line; and
at least one cleaning fluid storage container that stores a cleaning fluid therein,
at least one rinse fluid storage container that stores a rinse fluid therein,
at least one polish fluid storage container that stores a polish fluid therein, wherein
the pump is configured to pump fluid through the spray nozzle onto the vehicle surface and the flow meter measures an amount of fluid sprayed.

4. The system according to claim 3 further comprising:
a heating element disposed in the cleaning fluid storage container and configured to maintain a temperature range of the cleaning fluid inside the cleaning fluid storage container.

5. The system according to claim 3 further comprising:
a heating element disposed in the rinse fluid storage container and configured to maintain a temperature range of the rinse fluid inside the rinse fluid storage container.

6. The system according to claim 3 further comprising:
a heating element disposed in the polish fluid storage container and configured to maintain a temperature range of the polish fluid inside the polish fluid storage container.

7. The system according to claim 3 further comprising:
at least two cleaning fluid storage container mounts; and
at least two cleaning fluid storage containers, wherein
the at least two cleaning fluid storage containers are exchangeable by the robotic arm.

8. The system according to claim 3 further comprising:
at least one rinse fluid storage container mount; and
at least one rinse fluid storage container, wherein
the at least one rinse fluid storage containers is filled from the water storage tank.

9. The system according to claim 8 further comprising:
a pump disposed in the at least on rinse fluid storage container that pumps fluid through a line;
a flow meter connected to the line;
an end of an outtake tube affixed to the pump;
an opposing end of the outtake tube affixed to the at least one rinse fluid storage container that stores the rinse fluid therein.

10. The system according to claim 3 further comprising:
at least two polish fluid storage container mounts; and
at least two polish fluid storage containers, wherein
the at least two polish fluid storage containers are exchangeable by the robotic arm.

11. The system according to claim 1 wherein:
the control circuitry includes a change sensor configured to detect a low energy in the electrical power source and automatically start an engine of the vehicle to provide power to actuate the robotic arm.

12. The system according to claim 1 further comprising:
a vehicle contour map (VCM), wherein
the VCM includes coordinate data representative of the vehicle surface of said vehicle.

13. The system according to claim 12 wherein:
the VCM is preloaded in the control system.

14. The system according to claim 1 further comprising:
a plurality of torque sensors, wherein
the torque sensors are located in joints of the robotic arm and detect resistance to motion.

15. The system according to claim 14 wherein:
the control circuitry creates a vehicle contour map (VCM) that includes coordinate data representative of the vehicle surface based on torque sensor data obtained during an initiation process.

16. The system according to claim 1 comprising:
a plurality of contact sensors, wherein
the contact sensors are located on the robotic arm and detect contact between the arm and external objects.

17. The system according to claim 16 wherein:
the control circuitry creates a vehicle contour map (VCM) that includes coordinate data representative of the vehicle surface based on contact sensor data obtained during an initiation process.

18. The system according to claim 12 wherein:
the control system downloads the VCM from an external source.

19. The system according to claim 12 wherein:
an estimated time to clean, rinse, dry, and polish the vehicle is calculated from data recorded from past operation of the control system.

20. The system according to claim 12 wherein:
an estimated time to clean, rinse, dry, and polish the vehicle is calculated from data received from other similar apparatus within a given distance of the control system.
